(19) United States
(12) Patent Application Publication
(10) Pub. No.: US 2011/0313650 A1
(43) Pub. Date: Dec. 22, 2011

(54) INERTIAL SENSOR ORIENTATION DETECTION AND MEASUREMENT CORRECTION FOR NAVIGATION DEVICE

(75) Inventor: Phillip Tomé, Cortaillod (CH)

(73) Assignee: QUALCOMM Incorporated, San Deigo, CA (US)

(21) Appl. No.: 12/819,962

(22) Filed: Jun. 21, 2010

(51) Int. Cl. G01C 21/16; G06F 15/00; G01P 3/00; G01P 15/00

(52) U.S. Cl. 701/200; 702/141; 702/145

(57) ABSTRACT

Implementations relating to methods, apparatuses and systems are disclosed for obtaining corrected inertial measurements based on an observed orientation of an inertial sensor system relative to a reference body.

### BACKGROUND

1. Field

The subject matter disclosed herein relates to electronic devices, and more particularly to methods, apparatuses, and systems for use in and/or with electronic navigation devices.

2. Information

Navigation devices often support the popular and increasingly important wireless technology of satellite positioning systems (SPS) which include, for example, the Global Positioning System (GPS) and/or other like Global Navigation Satellite Systems (GNSSs). Navigation devices supporting SPS may obtain navigation signals as wireless transmissions received from one or more transmitter equipped satellites that may be used to estimate geographic position and heading. Some navigation devices may additionally or alternatively obtain navigation signals as wireless transmissions received from terrestrial based transmitters to estimate geographic position and heading.

Furthermore, some navigation devices may include one or more inertial sensors that reside on-board the navigation device. These inertial sensors may take the form of accelerometers or gyroscopes that may be used to measure an inertial state of the navigation device. Inertial measurements obtained from these inertial sensors may be used in combination with or independent of navigation signals received from satellite and/or terrestrial based transmitters to provide estimates of geographic position and heading.

### SUMMARY

Implementations relating to methods, apparatuses and systems are disclosed for obtaining corrected inertial measurements based on an observed orientation of an inertial sensor system relative to a reference body. In at least one implementation, a method is disclosed that comprises processing one or more linear inertial measurements and one or more rotational inertial measurements obtained from an inertial sensor system to obtain one or more transformation values based, at least in part, on a linear acceleration vector and a rotational velocity vector indicated by such inertial measurements. The one or more transformation values may be used to enable transformation of at least one subsequent inertial measurement obtained from the inertial sensor system to at least one corrected inertial measurement. It should be understood, however, that this is merely an example implementation, and that claimed subject matter is not limited in this respect.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is a schematic block diagram depicting an example navigation device according to one implementation.

FIG. 2 is a diagram depicting an example orientation of an inertial sensor system relative to a reference body.

FIG. 3 is a flow diagram depicting an example method for correcting inertial measurements to account for inertial sensor orientation relative to a reference body according to one implementation.

FIG. 4 is a flow diagram depicting an example method for updating transformation values responsive to an observed inertial state of a reference body according to one implementation.

FIG. 5 is a table depicting example conditions for utilizing inertial measurements to update transformation values for correcting inertial measurements according to one implementation.

FIG. 6 is a flow diagram depicting an example method for determining a position and/or heading of a navigation device according to one implementation.

### DETAILED DESCRIPTION

Some navigation devices may include one or more inertial sensors for obtaining inertial measurements with respect to a reference frame of the navigation device. Such inertial measurements may be utilized, at least in part, by a navigation device to estimate navigation information including, for example, geographic position and/or heading of the navigation device. Navigation devices may also reside on-board a moving reference body to enable such navigation information to be estimated related to that reference body. As a non-limiting example, a reference body may comprise a vehicle such as an automobile, train, boat, or aircraft.

In some examples, a reference frame of a navigation device may be offset relative to a reference frame of a reference body associated with the navigation device. For example, such an offset may comprise an angular offset of the navigation device relative to the reference body that may be characterized as a misalignment of the navigation device. As one example, a navigation device that is mounted to a reference body may be characterized as misaligned if an angular offset exists between a reference frame of the reference body and a reference frame of the navigation device. Such misalignment is likely to be present in the context of a navigation device that is adapted to be mounted to a reference body by a user at an orientation that is selected by the user based on user convenience or user preference. However, such misalignment may also be present even where a navigation device is mounted to the reference body by an installation specialist.

Such misalignment of a navigation device to a reference body caused by an angular offset of the navigation device may result in inaccurate estimates of navigation information with respect to the reference body. Accordingly, implementations relating to methods, apparatuses, and systems are disclosed herein to obtain corrected inertial measurements based, at least in part, on an observed orientation of an inertial sensor system relative to a reference body. The observed orientation of such an inertial sensor system may be based on linear inertial measurements and/or rotational inertial measurements obtained from the inertial sensor system during predefined inertial conditions of the reference body. One or more transformation values indicating the observed orientation of an inertial sensor system may be obtained for transforming inertial measurements subsequently obtained at the inertial sensor system to corrected inertial measurements.

This may allow for an inertial state of the reference body to be measured with respect to a reference frame of the reference body. Accordingly, by identifying an angular offset between reference frames of an inertial sensor system and a reference body, a user may be supplied with correct heading information of a vehicle reference body (e.g., as provided via turn-by-turn navigation software) and not the heading of the inertial sensor system enclosure. Corrected inertial measurements may be combined with navigation signal obtained from SPS and/or terrestrial based navigation systems to estimate a position and/or heading of the reference body with respect to the reference frame of the reference body. Furthermore, by identifying such angular offsets between reference frames, pseudo measurements called non-holonomic constraints (NHC) may be applied to significantly improve the overall performance of an integrated navigation system, therefore enabling a higher quality navigation solution (in position, velocity and attitude) to be provided to a user. It should be understood, however, that this is merely an example implementation, and that claimed subject matter is not limited in this respect.

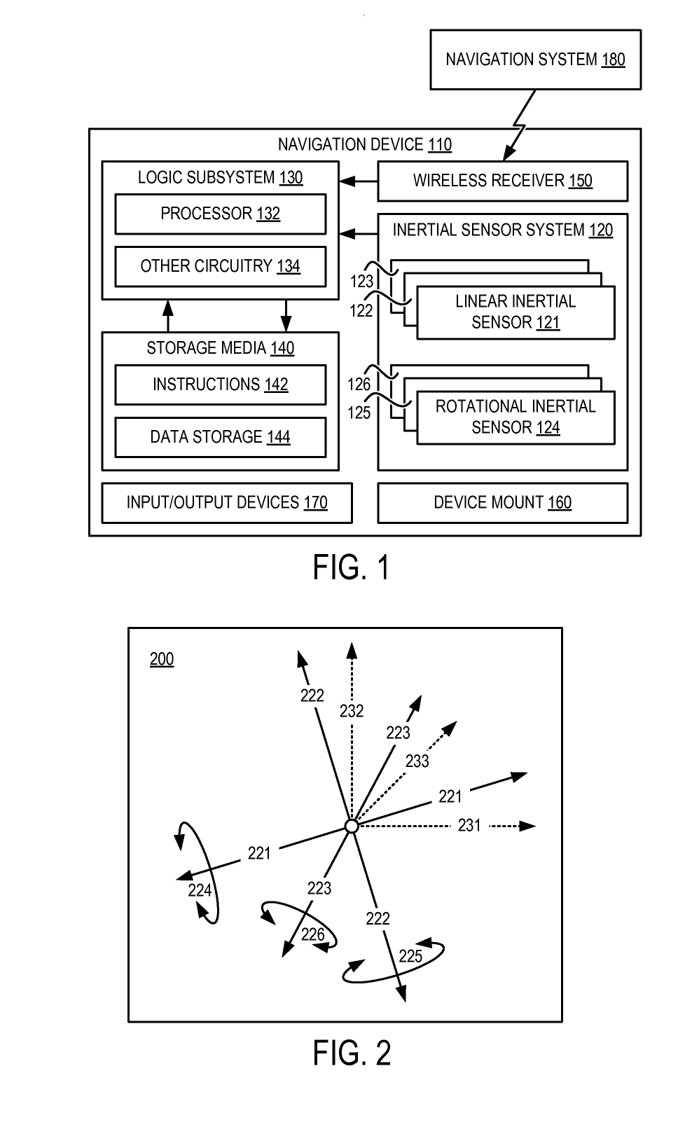

FIG. 1 is a schematic block diagram of an example navigation device 110 according to one implementation. Navigation device 110 may comprise one or more of an inertial sensor system 120, a logic subsystem 130, storage media 140, a wireless receiver 150, and a device mount 160. In at least some implementations, navigation device 110 may comprise a personal navigation device (PND), a vehicle navigation system, a mobile computing platform such as a mobile phone, personal digital assistant (PDA), laptop computer, or other suitable electronic device.

Inertial sensor system 120 may include one or more inertial sensors. In at least some implementations, inertial sensor system 120 may include one or more linear inertial sensors and may include one or more rotational inertial sensors. For example, inertial sensor system 120 as depicted in FIG. 1 includes three linear inertial sensors 121, 122, 123 and three rotational inertial sensors 124, 125, 126. However, as another example, an inertial sensor system may include two linear inertial sensors and one rotational inertial sensor.

Linear inertial sensors may comprise accelerometers or other suitable devices for measuring an inertial state of navigation device 110 along a linear axis. Linear inertial measurements obtained from such linear inertial sensors may indicate one or more of a position, a change of position, a linear velocity, a linear acceleration, and/or a rate of change of acceleration (i.e., jerk) of inertial sensor system 120. Rotational inertial sensors may comprise gyroscopes or other suitable devices for measuring an inertial state of navigation device 110 about an axis of rotation. Rotational inertial measurements obtained from such rotational inertial sensors may indicate one or more of an orientation, a change of orientation, a rotational velocity, a rotational acceleration, and/or a rotational rate of change of acceleration (i.e., jerk) of inertial sensor system 120. Such accelerometers and gyroscopes may comprise microelectromechanical systems (MEMS) in at least some implementations. It should be understood that such inertial sensors are relatively well known and that the herein described implementations are not limited to the above described inertial sensors. Furthermore, in some implementations, inertial sensor system 120 may further comprise one or more magnetometers to provide a measurement of a heading of inertial sensor system 120 relative to magnetic north. However, such magnetometers may be omitted from inertial sensor system 120 in some implementations.

FIG. 2 is a diagram depicting an example reference frame of an inertial sensor system offset relative to a reference frame of a reference body 200. As a non-limiting example, FIG. 2 depicts a reference frame of inertial sensor system 120 (e.g., defined by Cartesian coordinate axes 221, 222, and 223) at an orientation that is offset from a reference frame of a reference body (e.g., defined by Cartesian coordinate axes 231, 232, 233). Such an offset in this particular example comprises an angular offset between the reference frame of inertial sensor system 120 and the reference frame of reference body 200 that may be characterized as a misalignment of navigation device 110 relative to reference body 200 upon which or within which navigation device 110 is mounted, carried, or otherwise disposed.

While FIG. 2 depicts a reference frame of a navigation device defined by axes 221, 222, and 223 having an origin that is coincident with an origin of a reference frame of a reference body, it will be appreciated that such angular offsets may exist even where an origin of a reference frame of a navigation device is spaced apart from an origin of a reference frame of a reference body. Furthermore, it will be appreciated that angular offsets may exist between less than all of the coordinate axes defining a reference frame of a navigation device and the coordinate axes defining a reference frame of a reference body. For example, in some conditions, an angular offset may exist between only one or two coordinate axes of a navigation device and the corresponding coordinate axes of a reference body. Accordingly, a reference frame of a navigation device may be characterized as aligned with a reference frame of a reference body, for example, if each of the three Cartesian coordinate axes defining the reference frame of the navigation device are coincident with or at least parallel to each of the corresponding three Cartesian coordinate axes defining the reference frame of the reference body.

For example, with respect to inertial sensor system 120, linear inertial sensor 121 may obtain linear inertial measurements indicating a first acceleration component along a first axis 221; linear inertial sensor 122 may obtain linear inertial measurements indicating a second acceleration component along a second axis 222; and linear inertial sensor 123 may obtain linear inertial measurements indicating a third acceleration component along a third axis 223. In at least some implementations, axes 221, 222, and 223 may comprise Cartesian coordinate axes that are orthogonal to each other to provide acceleration components in one or more of the three spatial dimensions. If an inertial sensor system includes only two linear inertial sensors and one rotational inertial sensor, for example, the two linear inertial sensors may obtain linear inertial measurements along two axes (e.g., two orthogonal axes) forming a horizontal plane of the inertial sensor system, and a rotational inertial sensor may obtain rotational inertial measurements about a vertical axis of rotation that is orthogonal to the horizontal plane of the inertial sensor system. However, it will be appreciated that other suitable sensor orientations may be used in other implementations.

Rotational inertial sensors 124, 125, and 126 may obtain rotational inertial measurements indicating acceleration and/or velocity about one or more axes of rotation. In at least some implementations, the axes of rotation of rotational inertial sensors 124, 125, and 126 may comprise Cartesian coordinate axes that are orthogonal to each other. For example, rotational inertial sensor 124 may obtain rotational inertial measurements indicating a component rotational velocity vector 224 about first axis 221 or an axis parallel to first axis 221; rotational inertial sensor 125 may obtain rotational inertial measurements indicating a component rotational velocity vector 225 about second axis 222 or an axis parallel to second axis 222; and rotational inertial sensor 126 may obtain rotational inertial measurements indicating a component rotational velocity vector 226 about third axis 223 or an axis parallel to third axis 223. It will be appreciated that in other implementations, rotational inertial sensors 124, 125, and 126 may obtain inertial measurements indicating acceleration and/or velocity about axes of rotation that are offset from one or more of axes 221, 222, and/or 223, and that claimed subject matter is not limited in this respect.

Referring again to FIG. 1, logic subsystem 130 of navigation device 110 may include one or more processors such as processor 132 and/or other electronic circuitry 134 for processing inertial measurements obtained by inertial sensor system 120 and/or navigation signals obtained by wireless receiver 150. For example, storage media 140 may have instructions 142 stored thereon that are executable by one or more processors such as processor 132 to perform one or more of the methods, processes, and/or operations described herein. However, it will be appreciated that one or more of these methods, processes, and/or operations may be performed by other electronic circuitry 134 in some implementations without necessarily requiring a processor to execute instructions. Storage media 140 may further include data storage 144 enabling the storage and retrieval of data, for example, by processor 132.

In at least some implementations, wireless receiver 150 may obtain navigation signals from a navigation system 180. Navigation system 180 may comprise one or more of a Satellite Positioning System (SPS) and/or a terrestrial based positioning system. Satellite positioning systems may include, for example, the Global Positioning System (GPS), Galileo, GLONASS, GNSS, a system that uses satellites from a combination of these systems, or any SPS developed in the future. As used herein, an SPS will also be understood to include pseudolites or a combination of satellite vehicles and pseudolites. Pseudolites may also include ground-based transmitters in a context of a terrestrial based positioning system that broadcasts a PN code or other ranging code (e.g., similar to a GPS or CDMA cellular signal) modulated on an L-band (or other frequency) carrier signal, which may be synchronized with system time (e.g., an SPS time). It should be understood, however, that particular positioning techniques provided here are merely example positioning techniques, and that claimed subject matter is not limited in this respect. In other implementations, wireless receiver 150 may be omitted from navigation device 110.

Navigation device 110 may further comprise a device mount 160 in at least some implementations. Device mount 160 may be used to mount navigation device 110 (e.g., a body or chassis of navigation device 110) to a reference body such as, for example, a vehicle dashboard, instrument panel, etc. Accordingly, device 160 may comprise one or more of a mounting bracket that accepts fasteners, an adhesive surface, a suction surface, etc. In other implementations, device mount 160 may be omitted from navigation device 110.

Navigation device 110 may further comprise input/output devices 170 for receiving a data input from a user and/or presenting a data output to a user. For example, input devices may include one or more of a keypad, keyboard, touch-screen, a touch pad, a pointing device such as a mouse, a controller, etc., and/or a microphone. Output devices may include one or more of a graphical display such as a monitor or touch-screen, an audio speaker, etc.

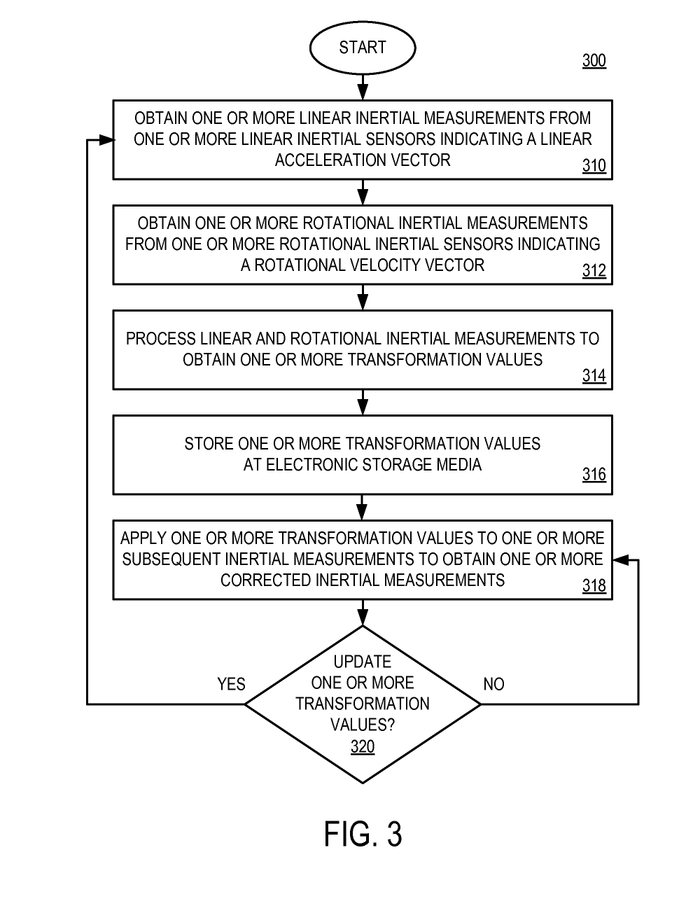

FIG. 3 is a flow diagram depicting an example method 300 for correcting inertial measurements to account for inertial sensor orientation relative to a reference body according to one implementation. Method 300 may be performed, at least in part, by one or more processors (e.g., processor 132) executing instructions (e.g., instructions 142) in at least some implementations. However, it will also be appreciated that method 300 may be performed, at least in part, by electronic circuitry (e.g., circuitry 134) in at least some implementations without necessarily executing instructions at a processor.

Inertial sensor orientation may be determined in method 300 by obtaining one or more inertial measurements. For example, at 310, one or more linear inertial measurements indicating a linear acceleration vector may be obtained from one or more linear inertial sensors. As one example, logic subsystem 130 may receive one or more electrical signals representative of one or more linear inertial measurements obtained at one or more of linear inertial sensors 121, 122, 123 indicating such a linear acceleration vector. Logic subsystem 130 may be adapted to receive the one or more electrical signals representative of the one or more linear inertial measurements from the one or more linear inertial sensors and determine a linear acceleration vector as measured in a reference frame of the inertial sensor system. In at least some implementations, linear inertial measurements obtained from linear inertial sensors and/or the linear acceleration vector indicated by such linear inertial measurements may be stored at electronic storage media 140 by logic subsystem 130 where it may be later retrieved for further processing.

At 312, one or more rotational inertial measurements indicating a rotational velocity vector may be obtained from one or more rotational inertial sensors. As one example, logic subsystem 130 may receive one or more electrical signals representative of the one or more rotational inertial measurements obtained at one or more of rotational inertial sensors 124, 125, 126 indicating the rotational velocity vector. Logic subsystem 130 may be adapted to receive the one or more electrical signals representative of the one or more rotational inertial measurements and determine the rotational velocity vector as measured in a reference frame of the inertial sensor system.

As previously described, an inertial sensor system of a navigation device may include any suitable number of linear inertial sensors and rotational inertial sensors. While method 300 is described in terms of three linear inertial sensors and three rotational inertial sensors, it will be understood that method 300 may be implemented, for example, in the context of an inertial sensor system having two linear inertial sensors and one rotational inertial sensor. In such implementations, an inertial sensor system may include two linear inertial sensors to obtain linear inertial measurements along two axes (e.g., two orthogonal axes) forming a horizontal plane of the inertial sensor system, and a rotational inertial sensor to obtain rotational inertial measurements about a vertical axis of rotation that is orthogonal to the horizontal plane of the inertial sensor system. However, it will be appreciated that other suitable sensor orientations may be used in still other implementations of method 300.

In at least some implementations, rotational inertial measurements obtained from rotational inertial sensors and/or the rotational velocity vector indicated by such rotational inertial measurements may be stored at electronic storage media 140 by logic subsystem 130 where it may be later retrieved for further processing.

At 314, the one or more linear inertial measurements obtained at 310 and the one or more rotational inertial measurements obtained at 312 may be processed to obtain a set of one or more transformation values. Such transformation values may be used (e.g., by logic subsystem 130) to correct subsequent inertial measurements obtained from the inertial sensor system based on an identified orientation of the inertial sensor system relative to the reference body. Accordingly, transformation values may be used to account for misalignment involving an angular offset of the inertial sensor system relative to the reference body.

For example, if at least two vectors (e.g., a linear acceleration vector and a rotational velocity vector indicating a rate of rotation) whose representation is known in both a reference frame of an inertial sensor system and a reference frame of a reference body, then an orientation of inertial sensor system representative of a mounting misalignment between the reference frames may be determined. As a non-limiting example, a triad of linear inertial sensors (e.g., accelerometers) and a triad of rotational inertial sensors (e.g., gyroscopes) may comprise an inertial sensor system of a navigation device.

The superscripts and subscripts of the following examples may refer to a reference frame (s) of an inertial sensor system and a reference frame (v) of a reference body. In a particular example these inertial sensors may provide measurements of specific force (f^{s}) and angular velocity (ωᵢₛ^{s}) with respect to a reference frame (s) of a navigation device. If a reference frame (s) of a navigation device and a reference frame (v) of a reference body are coincident then the navigation device on-board the reference body may provide measurements of specific force (f^{s}) and angular velocity (ωᵢₛ^{s}) that are equivalent to specific force (f^{v}) and angular velocity (ωᵢᵥ^{v}). As discussed above, in practice the alignment of the reference frame (s) of a navigation device may be offset from the reference frame (v) of a reference body. Such offset may comprise an angular offset where the reference frame (s) of a navigation device is rotated or angled relative to the reference frame (v) of a reference body.

For example, reference frame (v) of a reference body may be aligned with respect to a longitudinal and/or vertical axis of a reference body. Referring again to FIG. 2, axis 231 may be defined to be coincident with or at least parallel to a longitudinal axis of a vehicle reference body, for example, where the longitudinal axis is defined by the primary direction of travel of the vehicle. For example, a positive direction of axis 231 may point in a forward direction of travel of the vehicle. Axis 232 may be defined to be coincident with and/or at least parallel to a vertical axis of a vehicle reference body as defined, for example, relative to the gravitational vector when the vehicle resides on a level surface. By contrast, reference frame (s) of a navigation device associated with a vehicle may be oriented at an angle that is offset from the vehicle's reference frame (v) depending on how the navigation device is mounted to the vehicle.

Once sensor orientation is determined, inertial measurements obtained from the inertial sensor system and f^{s} and ωᵢᵥ^{s} values can be rotated from the s frame to the v frame where such measurements may be used in navigation mechanization equations, including f^{v}=Cₛ^{v}·f^{s} and ωᵢᵥ^{v}=Cₛ^{v}·ωᵢᵥ^{s}, where Cₛ^{v} is the Direction Cosine Matrix (DCM) representation of the mounting misalignment and the s to v frame rotation matrix corresponding to the one or more transformation values.

It should be highlighted that the navigation mechanization equations can still be used without transforming inertial measurements from the s to v frames, however, the attitude being determined in this case is relative to the reference frame of the inertial sensor system (Cₛ^{l}) and not the attitude relative to the reference frame of the reference body (Cᵥ^{l}) that is of interest to the user. Therefore, in this example, the mounting misalignment may be identified in order to determine the attitude of the reference body from the attitude of the inertial sensor system as defined as Cᵥ^{l}=Cₛ^{l}·Cₛ^{v}^{^{T}}.

At 316, the one or more transformation values (e.g., Cₛ^{v}) obtained at operation 314 may be stored at an electronic storage medium. For example, one or more transformation values may be stored on-board navigation device 110 at data storage 144 of electronic storage media 140 where such transformation values may be periodically referenced, updated, and/or retrieved by logic subsystem 130.

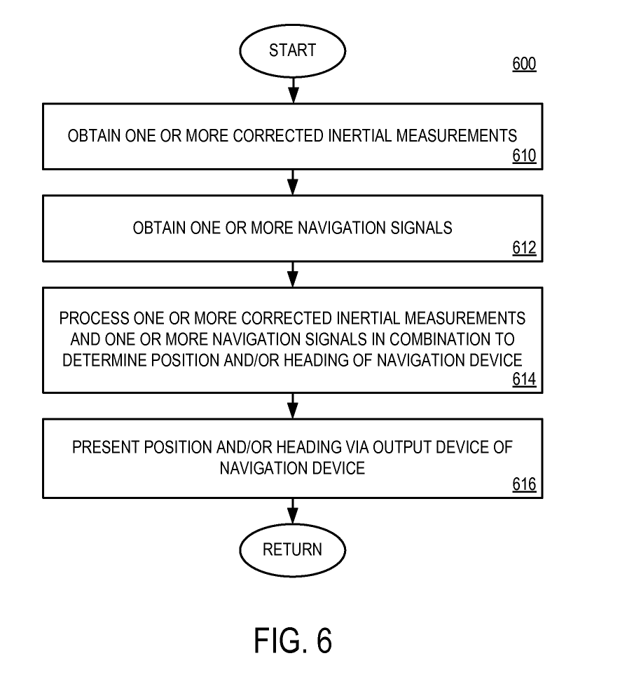

At 318, the one or more transformation values obtained at operation 314 may be applied to one or more subsequent inertial measurements to obtain one or more corrected inertial measurements that account for an orientation of the inertial sensors relative to the reference body. For example, logic subsystem 130 may apply the one or more transformation values to one or more inertial measurements subsequently received from inertial sensor system 120 to obtain corrected inertial measurements. Such corrected inertial measurements may include corrected linear inertial measurements and/or corrected rotational inertial measurements. As will be described in greater detail with reference to method 600 of FIG. 6, corrected inertial measurements obtained at 318 may be used in combination with navigation signals to determine a position and/or heading of the reference body.

At 320, if one or more transformation values obtained at 314 are to be updated, then one or more of operations 310-318 may be again performed to obtain one or more updated transformation values. In at least some implementations, transformation values may be updated based, at least in part, on a filtered combination of inertial measurements obtained at different times. For example, inertial measurements including linear inertial measurements and/or rotational inertial measurements may continue to be obtained from an inertial sensor system. A filtered combination of previously obtained inertial measurements and newly obtained inertial measurements may be determined, for example, by logic subsystem 130.

As a non-limiting example, linear inertial measurements processed at 314 may be weighted relative to linear inertial measurements obtained one or more different times based, at least in part, on a magnitude of their corresponding linear acceleration vectors. As one example, a weighting of one or more linear inertial measurements may be increased as a magnitude of an indicated linear acceleration vector increases and may be decreased as a magnitude of the indicated linear acceleration vector decreases.

In at least some implementations, filtered combination of rotational inertial measurements obtained at different times may also be weighted while processed at 314 based, at least in part, on a corresponding magnitude of the rotational velocity vector indicated by the rotational inertial measurements. As one example, a weighting of the rotational inertial measurements may be increased as a magnitude of the rotational velocity vector increases and may be decreased as a magnitude of the rotational velocity vector decreases. However, in other examples, a weighting of the rotational inertial measurements may be decreased as a magnitude of the rotational velocity vector increases and may be increased as a magnitude of the rotational velocity vector decreases for implementations where roll of the reference body (e.g., vehicle body roll) occurs at higher rotational accelerations.

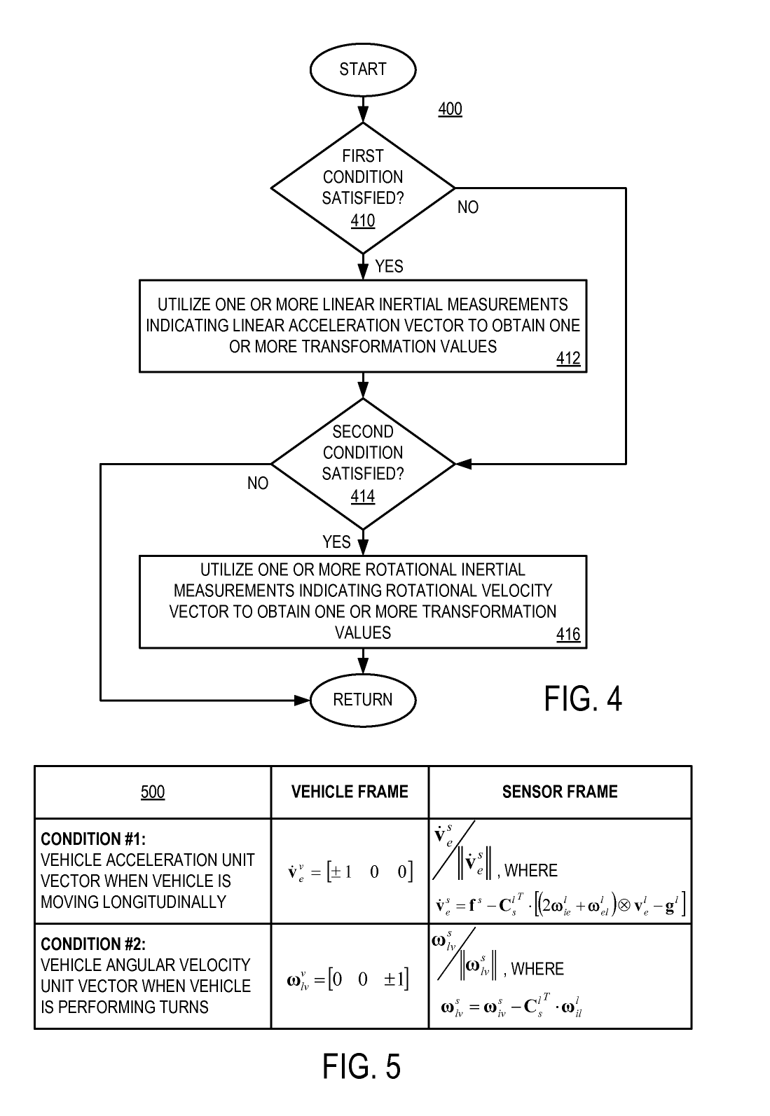

Updated transformation values may be used to account for changes in orientation of an inertial sensor system of a navigation device relative to a reference body. Such changes in orientation may occur, for example, if a mounting position of the navigation device is changed relative to the reference body or if the navigation device is used with a different reference body. FIG. 4 provides a non-limiting example method for judging whether to update the one or more transformation values. If, however, at 320, the one or more transformation values are not to be updated, then the one or more previously determined transformation values may continue to be applied to subsequent inertial measurements to obtain corrected inertial measurements.

At least one advantage of the methods described herein, including method 300 is that an orientation of an inertial sensor system may be identified without relying on an assumption that one or more planes of a reference frame of an inertial sensor system (e.g., a horizontal plane defined by axes 221 and 223 of FIG. 2) are aligned with (e.g., at least parallel to) one or more planes of a reference frame of a reference body (e.g., a horizontal plane defined by axes 231 and 233 of FIG. 2). For example, alternative approaches assume that when a reference body is at rest it is resting on a horizontal surface in order to determine roll and pitch orientations. However, such assumptions may be invalid in practical scenarios. For example, a reference body such as a vehicle may reside on an inclined surface such as a hill or ramp, thereby invalidating assumptions relied upon by such alternative approaches. By contrast, method 300 enables an orientation of a reference frame of an inertial sensor system to be identified with respect to a reference frame of a reference body without relying on such assumptions.

FIG. 4 is a flow diagram depicting an example method 400 for updating transformation values responsive to an observed inertial state of a reference body according to one implementation. Method 400 may be performed, at least in part, by one or more processors (e.g., processor 132) executing instructions (e.g., instructions 142) in at least some implementations. However, it will also be appreciated that method 400 may be performed, at least in part, by electronic circuitry (e.g., circuitry 134) in at least some implementations without necessarily executing instructions at a processor.

In many inertial sensor applications, inertial dynamics that are typical of a particular reference body may be useful for estimating an orientation of an inertial sensor system relative to that reference body. For example, where the reference body comprises a vehicle (e.g., an automobile), typical vehicle dynamics may be useful in estimating inertial sensor orientation in at least two ways. First, substantial linear accelerations of a vehicle in the absence of substantial rotational accelerations may be caused primarily by motion along a longitudinal axis of the vehicle. Referring also to FIG. 2, a longitudinal axis of a vehicle may correspond, for example, to coordinate axis 231 of reference body 200. Accordingly, substantial linear accelerations observed by the inertial sensor system in the absence of substantial rotational accelerations may be used to indicate the longitudinal axis of a reference body in at least some applications.

Referring again to FIG. 4, if a first condition is satisfied at 410 then one or more linear inertial measurements obtained from one or more linear inertial sensors during satisfaction of the first condition may be utilized to obtain one or more transformation values at operation 412. In at least some implementations, the first condition may be satisfied if a magnitude of the linear acceleration vector indicated, for example, at operation 310 is greater than a first threshold value (e.g., 200 mg) and a rate of rotation indicated by the rotational velocity vector indicated, for example, at operation 312 is less than a second threshold value (e.g., 1 degree per second). However, it will be appreciated that other suitable threshold values may be used to define the first condition.

Where weightings are assigned at method 300 among linear inertial measurements obtained at different times when updating the transformation values, such weightings may correspond to a confidence with which the first condition was satisfied at the time the linear inertial measurements were obtained. In at least some implementations, a weighting of the linear inertial measurements may be scaled to the first threshold utilized at 410 for identifying whether the first condition has been satisfied by dividing the linear acceleration vector by the first threshold.

At 412, one or more linear inertial measurements obtained from one or more linear inertial sensors during satisfaction of the first condition may be utilized to obtain one or more transformation values, for example, as previously described at operation 314 of method 300. For example, operation 412 may be performed to update one or more previously obtained transformation values to reflect linear inertial measurements that were more recently obtained during satisfaction of the first condition.

Alternatively, if the first condition is not satisfied at 410, the process flow of method 400 may proceed to 414 without utilizing the one or more linear inertial measurements that were obtained while the first condition was not satisfied. If one or more transformation values were previously obtained from linear inertial measurements previously obtained during satisfaction of the first condition, such transformation values may continue to be applied, for example, at operation 318, at least until the first condition is once again satisfied and new linear inertial measurements may be obtained.

A second way in which typical vehicle dynamics may be helpful for estimating inertial sensor orientation relies on the observation that substantial rotational velocities of a vehicle may be caused primarily by turning of the vehicle about a vertical axis of rotation. Referring also to FIG. 2, a vertical axis of rotation for a vehicle may correspond, for example, to coordinate axis 232 of reference body 200. Accordingly, satisfaction of a second condition that includes substantial rotational velocities observed by the inertial sensor system may be used to indicate a vertical axis of a reference body in at least some applications.

For example, if a second condition is satisfied at 414, then one or more rotational inertial measurements obtained from one or more rotational inertial sensors indicating a rotational velocity vector may be utilized to obtain one or more transformation values at operation 416. As a non-limiting example, the second condition may be satisfied if a rate of rotation indicated by the rotational velocity vector indicated, for example, at operation 312 meets or exceeds a third threshold value (e.g., 5 degrees per second). In at least some implementations, the third threshold value may be greater than the second threshold value used to satisfy the first condition. However, it will be appreciated that other suitable threshold values may be used to define the second condition.

For implementations where weightings are assigned among rotational inertial measurements obtained over a period of time, such weightings may correspond to a confidence with which the second condition was satisfied at the time the rotational inertial measurements were obtained. In at least some implementations, a weighting of the rotational inertial measurements may be scaled to the third threshold utilized at 410 for identifying whether the first condition has been satisfied (e.g., by dividing the rotational velocity vector by the third threshold).

At 416, one or more linear inertial measurements may be utilized to obtain one or more transformation values as previously described, for example, at operation 314. For example, operation 416 may be performed to update one or more previously obtained transformation values to reflect rotational inertial measurements that were obtained during satisfaction of the second condition.

Alternatively, if the second condition is not satisfied at 414, the process flow of method 400 may return without utilizing the one or more rotational inertial measurements obtained from one or more rotational inertial sensors while the second condition was not satisfied. In this way, one or more previously obtained transformation values may continue to be applied to inertial measurements to obtain corrected inertial measurements, at least until the second condition is once again satisfied.

FIG. 5 is a table 500 depicting example conditions for utilizing inertial measurements to update transformation values for correcting inertial measurements according to one implementation. As a non-limiting example, table 500 depicts the first condition and the second condition previously described with reference to method 400 of FIG. 4. The two conditions depicted in table 500 of FIG. 5 translate to known acceleration and angular velocity vectors in a reference frame of a reference body which are also measured in a reference frame of an inertial sensor system by one or more linear and/or rotational inertial sensors.

As shown in table 500 of FIG. 5, an acceleration unit vector during satisfaction of the first condition may be positive (e.g., +1) during acceleration of the reference body or negative (e.g., −1) during deceleration of the reference body. In at least some implementations, logic subsystem 130 may be adapted to distinguish between acceleration and deceleration of a reference body based on typical dynamic characteristics of the reference body. In at least some examples, it may be assumed that a navigation device will not have a misalignment (e.g., represented by an offset between a sensor reference frame and a vehicle reference frame) that is greater than 90 degrees. For example, it may be assumed that a user or a technician installing a navigation device in or on a vehicle may be unlikely to orient a graphical display of the navigation device such that it substantially faces away from the vehicle operator or passengers (e.g., so that the graphical display faces outward from the vehicle or toward a windshield of the vehicle). Here, if such an assumption is relied upon, acceleration and deceleration may be distinguished by positive and negative signs of one or more linear inertial measurements of acceleration in a horizontal axis or plane of the navigation device.

Similarly, an angular velocity unit vector during satisfaction of the second condition may be positive (e.g., +1) during a right turn of the reference body or negative (e.g., −1) during a left turn of the reference body. In at least some implementations, logic subsystem 130 may be adapted to distinguish between right turns and left turns of a reference body based on accelerations obtained from linear acceleration sensors which corresponds to a centrifugal force experienced at the reference body during a turn. For example, right and left turns may be identified if an acceleration is also measured in a linear acceleration vector (e.g., along coordinate axis 233) that is orthogonal to both the vertical axis of rotation and the longitudinal axis of the reference body. In such implementations, a right turn may be identified about a vertical axis of rotation (e.g., axis 232) if a positive acceleration vector is also measured along axis 233. Conversely, a left turn may be identified about a vertical axis of rotation (e.g., axis 232) if a negative acceleration vector is also measured along axis 233. However, if it is again assumed that a navigation device will not have a misalignment that is greater than 90 degrees, then other suitable approaches may be utilized to distinguish a right turn from a left turn. For example, it may be assumed in at least some examples that a user or a technician will not install a navigation device in or on a vehicle so that a graphical display is facing up-side down. Here, if such an assumption is relied upon, right turns may be distinguished from left turns by positive and negative signs of one or more rotational inertial measurements of acceleration about a vertical axis of the navigation device.

FIG. 6 is a flow diagram depicting an example method 600 for determining a position and/or heading of a navigation device according to one implementation. Method 600 may be performed, at least in part, by one or more processors (e.g., processor 132) executing instructions (e.g., instructions 142) in at least some implementations. However, it will also be appreciated that method 400 may be performed, at least in part, by electronic circuitry (e.g., circuitry 134) in at least some implementations without necessarily executing instructions at a processor.

At 610, one or more corrected inertial measurements may be obtained, for example, as previously described with reference to operation 318 of method 300. At 612, one or more navigation signals may be obtained, for example, from navigation system 180 via wireless receiver 150.

At 614, the one or more corrected inertial measurements obtained at operation 610 and the one or more navigation signals obtained at operation 612 may be processed in combination to determine an orientation and/or a heading of the navigation device. In at least some implementations, logic subsystem 130 may comprise an Extended Kalman Filter (EKF) for processing navigation signals in combination with corrected inertial measurements. At 616, the position and/or heading determined at operation 614 may be presented at the navigation device via an output device (e.g., a graphic display, audio speaker, etc.).

It will be appreciated that the sensor frame equations of table 500 of FIG. 5 include terms that may depend on a velocity of the reference body, such as Coriolis terms ((2ωᵢₑ^{l}+ωₑₗ^{l}) [symbol] vₑ^{l}), the transport rate (ωᵢₗ^{l}) and the attitude of the inertial sensor system (Cₛ^{l}). In an attempt to obtain geographic position and heading independent of one or more navigation signals, method 600 may be performed in some implementations by logic subsystem 130 so as to neglect the velocity dependent terms with minor impact on performance. However, the attitude term (Cₛ^{l}) from which the heading angle can be extracted may also be utilized to remove the gravity effect (g^{l}) from the accelerometer measurements, as expressed in the inertial sensor acceleration equation presented in table 500 of FIG. 5.

To overcome this difficulty, methods 300 and/or 400, which may be use to obtain corrected inertial measurements for misaligned inertial sensor systems, may be performed concurrently with method 600 where the attitude Cₛ^{l} is being estimated. In implementations where navigation device 110 also includes one or more magnetometers for indicating a heading of the navigation device relative to magnetic north, an approximation for attitude Cₛ^{l} of the inertial sensor system may be independently obtained from one or more magnetometer measurements. Accordingly, compensation of the gravity effect on the inertial measurements may be obtained without depending on the availability of GPS information or other SPS information applied at operations 614 of method 600, for example.

Where an orientation of the inertial sensor system has not yet been observed with sufficient confidence, non-holonomic constraint (NHC) measurements may not be applied to the EKF at operation 614. For example, NHC measurements are defined in the vehicle's frame but the misalignment of the inertial sensor system is not yet known for correcting inertial measurements. For this reason, the vehicle's attitude (e.g., roll, pitch, and/or yaw) may not be presented to a user at operation 616 until an orientation of the inertial sensor system is observed with sufficient confidence to enable correction of inertial measurements. Once methods 300 and/or 400 are sufficiently converged (e.g., over one, two, or more sets of inertial measurements obtained at different periods of time) to enable correction of inertial measurements that accounts for inertial sensor system orientation, the EKF may continue to run at operation 614, but may now use NHC measurements to improve performance, whereby the attitude of the reference body may be presented to the user at operation 616.

Another advantage of the methods described herein is that they are less sensitive to lower quality navigation signals (e.g., GPS signals) obtained from a navigation system. For example, referring once again to the sensor frame equation associated with condition #1 of FIG. 5, a specific force measurement supplied by inertial sensors may be corrected to account for Coriolis and gravitational effects. Coriolis effects become more negligible as a velocity of a reference body decreases. For example, a vehicle reference body may be operated at lower speed in a congested urban environment. Such urban environments may also provide locations where navigation signals may be of reduced quality as a result of obstructions such as buildings or other features that at least partially block the reception of navigation signals by the navigation device. However, the question of whether the gravitational vector is parallel to a vertical axis of the reference body depends more on the accuracy of the roll and pitch orientation of the inertial sensor frame with respect to the reference frame of the reference body. Roll and pitch angles may be far more observable than a heading angle and less dependent on a quality of the navigation signals obtained from a navigation system. This is especially valid if Zero Velocity Updates (ZUPTs) for the navigation system are frequently obtained, thereby enabling the roll and pitch angles to be quickly estimated and the gravity vector effect removed from the inertial measurements. On the other hand, if the angular velocity equation of condition #2 of FIG. 5 is analyzed, an orientation of an inertial sensor system may be used to remove a rotational effect (e.g., Coriolis effect) of a reference frame of a reference body. For reference bodies operating at lower speeds, the rotational effect reduces to the angular velocity of the Earth and an error in the orientation estimation has little impact as compared to other sources of error.

In at least some implementations, processing of inertial measurements to account for differences in alignment between a sensor reference frame and a vehicle reference frame may be limited to reduce computational load for a navigation device. For example, transformation values may be applied to inertial measurements (e.g., at operation 318) to obtain corrected inertial measurements. Obtaining corrected inertial measurements may be computationally intensive in some examples if all or a substantial portion of the inertial measurements are processed to obtain corrected inertial sensors measurements. In some implementations, for example, operation 318 may performed at a rate at which the inertial measurements are supplied by the inertial sensors (e.g., greater than 100 Hz for some automotive implementations) to transform all inertial measurements to corrected inertial measurements. However, to limit computational load, transformation of inertial measurements may be performed during select conditions. As one example, vehicle heading may be supplied to a user at a lower rate (e.g., 1-10 Hz) than an inertial measurement rate (e.g., 100 Hz). Hence, if vehicle heading is to be supplied to a user, then inertial measurements may be transformed by application of one or more transformation values to convert sensor reference frame orientation estimated, for example, in an EKF to a vehicle reference frame orientation (e.g., the heading of the vehicle reference frame that the user is expecting to be presented with rather than the sensor reference frame). As another example, transformation values may be applied (e.g., at operation 318) to apply non-holonomic constraint (NHC) measurements to an EKF, which may also be performed at a lower rate (e.g., 10 Hz or less) than a rate at which inertial measurements may be obtained from inertial sensors (e.g., 100 Hz). Accordingly, in at least some implementations, transformation of inertial measurements to obtain corrected inertial measurements may be limited to instances where a vehicle orientation (e.g., heading) is to be presented to a user or where applying NHC measurements to an EKF. However, it will be understood that these two example situations are merely non-limiting examples of conditions where processing of inertial measurements may be limited to reduce computational load.

The navigation devices described herein may be enabled for use with various wireless communication networks such as a wireless wide area network (WWAN), a wireless local area network (WLAN), a wireless personal area network (WPAN), and so on. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network may implement one or more radio access technologies (RATs) such as cdma2000, Wideband-CDMA (W-CDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may include an IEEE 802.11x network, and a WPAN may include a Bluetooth network, an IEEE 802.15x, for example.

The methodologies described herein may be implemented in different ways and with different configurations depending upon the particular application. For example, such methodologies may be implemented in hardware, firmware, and/or combinations thereof, along with software. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

The herein described storage media may comprise primary, secondary, and/or tertiary storage media. Primary storage media may include memory such as random access memory and/or read-only memory, for example. Secondary storage media may include mass storage such as a magnetic or solid state hard drive. Tertiary storage media may include removable storage media such as a magnetic or optical disk, a magnetic tape, a solid state storage device, etc. In certain implementations, the storage media or portions thereof may be operatively receptive of, or otherwise configurable to couple to, other components of a computing platform, such as a processor. In at least some implementations, one or more portions of the herein described storage media may store signals representative of data and/or information as expressed by a particular state of the storage media. For example, an electronic signal representative of data and/or information may be “stored” in a portion of the storage media (e.g., memory) by affecting or changing the state of such portions of the storage media to represent data and/or information as binary information (e.g., ones and zeros). As such, in a particular implementation, such a change of state of the portion of the storage media to store a signal representative of data and/or information constitutes a transformation of storage media to a different state or thing.

Some portions of the preceding detailed description have been presented in terms of algorithms or symbolic representations of operations on binary digital electronic signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels.

Unless specifically stated otherwise, as apparent from the above description, it is appreciated that throughout this specification discussions utilizing terms such as “processing,” “computing,” “calculating,”, “identifying”, “determining”, “establishing”, “obtaining”, and/or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or other like phrases in various places throughout this specification are not necessarily all referring to the same feature, example, and/or limitation. Furthermore, the particular features, structures, or characteristics may be combined in one or more examples and/or features. In the preceding detailed description, numerous specific details have been set forth to provide a thorough understanding of claimed subject matter.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of appended claims, and equivalents thereof.

What is claimed is:

1. A method, comprising:
processing one or more linear inertial measurements and one or more rotational inertial measurements obtained from an inertial sensor system to obtain one or more transformation values based, at least in part, on a linear acceleration vector and a rotational velocity vector indicated by said measurements,
said one or more transformation values enabling transformation of at least one subsequent inertial measurement obtained from the inertial sensor system to at least one corrected inertial measurement.

2. The method of claim 1, further comprising:
obtaining the at least one subsequent inertial measurement from the inertial sensor system; and
applying the one or more transformation values to the at least one subsequent inertial measurement to obtain the at least one corrected inertial measurement based, at least in part, on the one or more transformation values.

3. The method of claim 1, wherein processing the one or more linear inertial measurements further comprises:
processing the one or more linear inertial measurements in response to the linear acceleration vector meeting or exceeding a first threshold value.

4. The method of claim 3, wherein processing the one or more linear inertial measurements further comprises:
processing the one or more linear inertial measurements in response to a rate of rotation indicated by the rotational velocity vector obtained from the one or more rotational inertial sensors being less than a second threshold value.

5. The method of claim 4, wherein processing the one or more rotational inertial measurements further comprises:
processing the one or more rotational inertial measurements in response to the rotational velocity vector indicating a rate of rotation meeting or exceeding a third threshold value;
wherein the third threshold value is greater than the second threshold value.

6. The method of claim 1, wherein obtaining the one or more linear inertial measurements further comprises:
obtaining at least three linear inertial measurements indicating the linear acceleration vector from at least three linear inertial sensors of the inertial sensor system; and
wherein processing the one or more linear inertial measurements further comprises:
determining the linear acceleration vector as a combination of the at least three linear inertial measurements.

7. The method of claim 1, wherein obtaining the one or more rotational inertial measurements further comprises:
obtaining at least three rotational inertial measurements indicating the rotational velocity vector from at least three rotational inertial sensors of the inertial sensor system; and
wherein processing the one or more rotational inertial measurements further comprises:
determining the rotational velocity vector as a combination of the at least three rotational inertial measurements; and
wherein the one or more transformation values is further based, at least in part, on a rate of rotation indicated by the rotational velocity vector.

8. The method of claim 1, further comprising:
applying the one or more transformation values to the at least one subsequent inertial measurement to obtain the at least one corrected inertial measurement based, at least in part, on the one or more transformation values; and
processing the at least one corrected inertial measurement to obtain an indication of a geographic position and/or heading of the inertial sensor system.

9. The method of claim 8, wherein processing the at least one corrected inertial measurement further comprises:
processing the at least one corrected inertial measurement in combination with one or more navigation signals obtained at a wireless receiver from a navigation system to obtain the indication of the geographic position and/or heading of the inertial sensor system.

10. The method of claim 8, wherein the one or more linear inertial measurements comprise a set of linear inertial measurements of a plurality of sets of linear inertial measurements obtained from the one or more linear inertial sensors;
wherein the method further comprises processing the plurality of sets of linear inertial measurements to obtain the one or more transformation values;
wherein the set of linear inertial measurements is weighted relative to one or more other sets of linear inertial measurements based, at least in part, on a magnitude of the linear acceleration vector relative to one or more other linear acceleration vectors indicated by the one or more other sets of linear inertial measurements.

11. A system, comprising:
a navigation device, comprising:
an inertial sensor system comprising one or more inertial sensors;
an electronic storage medium; and
a logic subsystem to:
process one or more linear inertial measurements and one or more rotational inertial measurements obtained from an inertial sensor system to obtain one or more transformation values based, at least in part, on a linear acceleration vector and a rotational velocity vector indicated by said measurements,
said one or more transformation values enabling transformation of at least one subsequent inertial measurement obtained from the inertial sensor system to at least one corrected inertial measurement.

12. The system of claim 11, wherein the logic subsystem is further adapted to:
apply the one or more transformation values to the at least one subsequent inertial measurement to obtain the at least one corrected inertial measurement based, at least in part, on the one or more transformation values.

13. The system of claim 11, wherein the inertial sensor system further comprises:
at least three linear inertial sensors for obtaining the one or more linear inertial measurements; and
at least three rotational inertial sensors for obtaining the one or more rotational inertial measurements.

14. The system of claim 11, wherein the logic subsystem is further adapted to process the one or more linear inertial measurements in response to the linear acceleration vector meeting or exceeding a first threshold value.

15. The system of claim 14, wherein the logic subsystem is further adapted to process the one or more linear inertial measurements in response to a rate of rotation indicated by the rotational velocity vector obtained from the one or more rotational inertial sensors being less than a second threshold value.

16. The system of claim 15, wherein the logic subsystem is further adapted to process the one or more rotational inertial measurements in response to the rotational velocity vector indicating a rate of rotation meeting or exceeding a third threshold value;
wherein the third threshold value is greater than the second threshold value.

17. The system of claim 11, wherein the logic subsystem is further adapted to:
apply the one or more transformation values to the at least one subsequent inertial measurement to obtain the at least one corrected inertial measurement based, at least in part, on the one or more transformation values; and
process the at least one corrected inertial measurement to obtain an indication of a geographic position and/or heading of the navigation device.

18. The system of claim 11, further comprising a wireless receiver; and
wherein the logic subsystem is further adapted to:
process the at least one corrected inertial measurement in combination with one or more navigation signals obtained at the wireless receiver from a navigation system to obtain an indication of geographic position and/or heading of the inertial sensor system.

19. The system of claim 11, wherein the logic subsystem comprises a computing platform including one or more processors programmed with instructions.

20. An electronic storage media having instructions stored thereon executable by one or more processors to:
process one or more linear inertial measurements and one or more rotational inertial measurements obtained from an inertial sensor system to obtain one or more transformation values based, at least in part, on a linear acceleration vector and a rotational velocity vector indicated by said measurements,
said one or more transformation values enabling transformation of at least one subsequent inertial measurement obtained from the inertial sensor system to at least one corrected inertial measurement.

21. The electronic storage media of claim 20, wherein the instructions are further executable by the one or more processors to:
apply the one or more transformation values to the at least one subsequent inertial measurement to obtain the at least one corrected inertial measurement based, at least in part, on the one or more transformation values.

22. A system, comprising:
means for obtaining one or more linear inertial measurements indicating a linear acceleration vector;
means for obtaining one or more rotational inertial measurements indicating a rotational velocity vector;
means for processing the one or more linear inertial measurements and the one or more rotational inertial measurements to obtain one or more transformation values based, at least in part, on the linear acceleration vector and the rotational velocity vector; and
means for applying the one or more transformation values to at least one subsequently obtained inertial measurement to transform the at least one inertial measurement to at least one corrected inertial measurement.
